(19) United States
(12) Patent Application Publication
(10) Pub. No.: US 2019/0221814 A1
(43) Pub. Date: Jul. 18, 2019

(54) CELL MODULE

(71) Applicant: Panasonic Intellectual Property Management Co., Ltd., Osaka (JP)

(72) Inventor: KEISUKE SHIMIZU, Osaka (JP)

(21) Appl. No.: 16/318,700

(22) PCT Filed: Sep. 12, 2017
(86) PCT No.: PCT/JP2017/032761

§ 371 Date: Jan. 17, 2019

(30) Foreign Application Priority Data
Sep. 29, 2016 (JP) 2016-192184

(51) Int. Cl. H01M 2/20; H01M 2/10

(52) U.S. Cl. CPC H01M 2/204; H01M 2/1077; H01M 2/206; H01M 2/105

(57) ABSTRACT

A battery module includes a plurality of cells being each cylindrical and being held in a cell holder such that the cells are arranged with positive electrodes disposed at a first side and negative electrodes disposed at a second side. The battery module further includes a plurality of positive-electrode current collector plates disposed adjacent to the positive electrodes of the plurality of cells, a plurality of negative-electrode current collector plates disposed adjacent to the negative electrodes of the plurality of cells, and bus bars being disposed in containers in the cell holder and being parallel to the plurality of cells. The containers are capable of containing the cells. Both ends of each of the bus bars are connected to one of the plurality of positive-electrode current collector plates and one of the plurality of negative-electrode current collector plates, respectively.

### TECHNICAL FIELD

The present disclosure relates to a cell module or battery module.

### BACKGROUND ART

A conventionally known cell module or battery module has a configuration described in PTL 1. In this configuration, cylindrical cells are contained in a plurality of respective cylindrical holes formed in a cell case equivalent to a cell holder. Two plates are disposed at both sides of the cell case. The two plates are equivalent to a positive-electrode current collector plate and a negative-electrode current collector plate. The plurality of cylindrical cells has positive electrode terminals and negative electrode terminals that are connected to the respective two plates by welding.

### CITATION LIST

### Patent Literature

PTL 1: International Patent Publication No. 2014/132649

### SUMMARY OF THE INVENTION

### Technical Problem

Battery modules are required to have a variety of shapes or structures in accordance with purposes and specifications. Even a battery module in a constant size is subject to frequent change in its connection pattern such as a cell type and numbers of cells connected in series or parallel, for example. This results in increases in production time and costs because every change made to the connection pattern necessitates changing the design of many parts and verifying the changed design. In response to a change in connection pattern, the structure of the cell holder needs to be substantially changed. Meanwhile, numbers of a plurality of cells connected in series or parallel may be altered by interchanging positive electrodes and negative electrodes of some of the cells relative to the remaining cells so as to change orientation of the cells. However, a change in orientation of the cells entails a complicated structure of the cell holder.

It is an object of the present disclosure to provide a battery module that allows alteration of a connection pattern for cells without any change in the cells' orientation and cell holder.

### Solution to Problem

A battery module according to an aspect of the present disclosure includes a plurality of cells being each cylindrical and being held in a cell holder such that the cells are arranged with positive electrodes disposed at a first side and negative electrodes disposed at a second side. The battery module further includes a plurality of positive-electrode current collector plates disposed adjacent to the positive electrodes of the plurality of cells, a plurality of negative-electrode current collector plates disposed adjacent to the negative electrodes of the plurality of cells, and a bus bar being disposed in a container in the cell holder and being parallel to the plurality of cells. The container is capable of containing any one of the cells. Both ends of the bus bar are connected to one of the plurality of positive-electrode current collector plates and one of the plurality of negative-electrode current collector plates, respectively.

### Advantageous Effect of Invention

A battery module according to the present disclosure allows alteration of a connection pattern for cells without any change in the cells' orientation and cell holder.

### BRIEF DESCRIPTION OF DRAWINGS

FIG. 1 is an exploded perspective view illustrating an overall configuration of a battery module according to an example of an exemplary embodiment.

FIG. 2 is a top view of cells and bus bars illustrated in FIG. 1.

FIG. 3 is an enlarged top view of positive-electrode current collector plates illustrated in FIG. 1.

FIG. 4 is an enlarged top view of negative-electrode current collector plates illustrated in FIG. 1.

FIG. 5 is an enlarged cross-sectional view taken from line A-A of FIG. 1, with the cells contained in a cell holder in FIG. 1.

FIG. 6 is a drawing comparable to FIG. 5, illustrating a battery module according to a second example of the exemplary embodiment.

FIG. 7 is a drawing comparable to FIG. 3, illustrating positive-electrode current collector plates of a battery module according to a third example of the exemplary embodiment.

FIG. 8 is a drawing comparable to FIG. 4, illustrating negative-electrode current collector plates of the battery module according to the third example of the exemplary embodiment.

FIG. 9 is a schematic top view illustrating a positional relationship among a plurality of cells, bus bars, and positive-electrode current collector plates of a battery module according to a fourth example of the exemplary embodiment.

FIG. 10 is a schematic top view illustrating a positional relationship among the plurality of cells, the bus bars, and negative-electrode current collector plates of the battery module according to the fourth example of the exemplary embodiment.

FIG. 11 is an exploded perspective view illustrating an overall configuration of a battery module according to a fifth example of the exemplary embodiment.

FIG. 12 is a view corresponding to a cross-sectional view illustrating a connected state of the cells in FIG. 11 omitting a cell holder, viewed along line B-B in FIG. 11.

FIG. 13 is an exploded perspective view illustrating an overall configuration of a battery module according to a sixth example of the exemplary embodiment.

### DESCRIPTION OF EMBODIMENT

A battery module according to an example of an exemplary embodiment will now be described in detail. Drawings referred to in a description of the exemplary embodiment are schematically drawn, and dimensions and proportions of configuration elements illustrated in the drawings may differ from those of actual components. Thus, specific dimensions and proportions should be understood in view of the following description. In the description herein, “substantially identical” means absolutely identical, as well as virtually identical, for example. Other words modified by “substantially” should be interpreted in the same manner. An “end” of an object means an edge and a nearby part of the object. Shapes, materials, piece counts, numerical values, and other particulars described below are provided for purposes of illustration and may be changed depending on specifications of battery modules. In the following description, identical or equivalent components are denoted by identical reference signs.

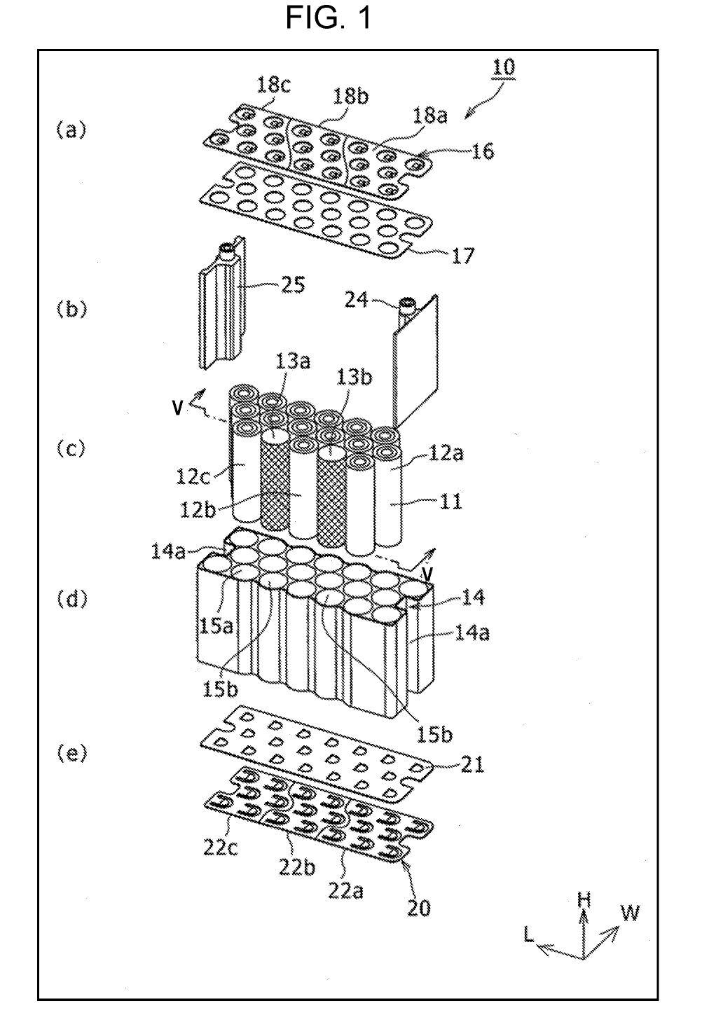

FIG. 1 is an exploded perspective view illustrating an overall configuration of battery module 10. Battery module 10 includes a plurality of parallel groups 12a, 12b, 12c that each have a plurality of parallel-connected cells 11. The battery module is designed to have a predetermined voltage and a predetermined capacity while parallel groups 12a, 12b, 12c are connected in series via cylindrical bus bars 13a, 13b described later. In this example, the battery module includes 15 cells 11.

Specifically, in battery module 10, 15 cells 11 shown in a section c of FIG. 1 are contained and held in cell holder 14 such that the cells are arranged with positive electrodes disposed at a first side (an upper side in FIG. 1) and negative electrodes disposed at a second side (a lower side in FIG. 1). The battery module includes positive-electrode current collector 16 disposed on the positive electrodes of 15 cells 11 and negative-electrode current collector 20 disposed on the negative electrodes of the cells. Positive-electrode current collector 16 and negative-electrode current collector 20 are fastened together through posts 24, 25 by proper fasteners (not shown).

Height direction H, lengthwise direction L, and widthwise direction W shown in FIG. 1 are three axial directions perpendicular to one another. Height direction H is a length direction of cell 11 and a vertical direction of FIG. 1. Lengthwise direction L is a longitudinal direction of cell holder 14 as viewed from the top, whereas widthwise direction W is a transverse direction of cell holder 14 as viewed from the top. The top and the bottom are terms used for the convenience of description.

Cell 11 is a secondary battery that can be charged and discharged. Examples of the secondary battery include lithium ion batteries. The secondary battery may be another battery such as a nickel hydride battery or an alkaline battery. The section c of FIG. 1 is a perspective view of 15 cells 11 and bus bars 13a, 13b contained and arranged in battery module 10. In FIG. 1, bus bars 13a, 13b are shown by a slanting lattice pattern.

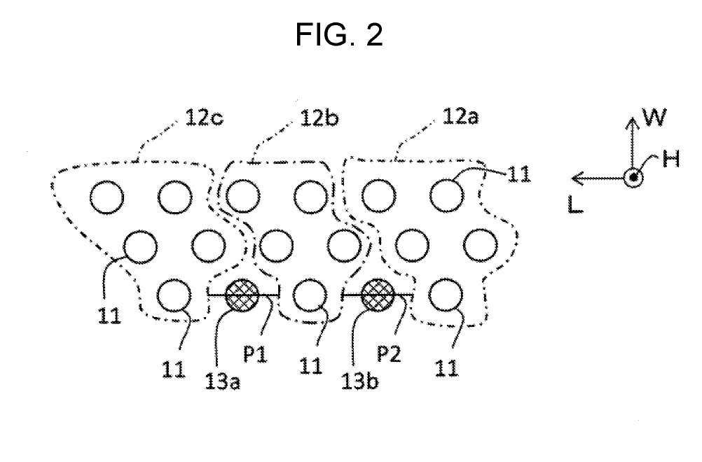

FIG. 2 is a top view of cells 11 and bus bars 13a, 13b illustrated in FIG. 1. Fifteen cells 11 are divided into three parallel groups 12a, 12b, 12c such that five pieces of cells 11 are together disposed in each one of parallel groups 12a, 12b, 12c. Of three parallel groups 12a, 12b, 12c, parallel group 12a disposed at a first end (a right end in FIG. 2) in lengthwise direction L represents cells at a positive terminal side, whereas parallel group 12c disposed at a second end (a left end in FIG. 2) in lengthwise direction L represents cells at a negative terminal side. Of three parallel groups 12a, 12b, 12c, parallel group 12b at a middle in lengthwise direction L is connected between parallel groups 12a, 12c at the positive and the negative terminal sides. To connect three parallel groups 12a, 12b, 12c in series, two cylindrical bus bars 13a, 13b are used. In FIG. 2, straight lines P1, P2 schematically show connection of parallel groups 12a, 12b, 12c through bus bars 13a, 13b. Hereinbelow, bus bars 13a, 13b are sometimes collectively referred to as bus bars 13.

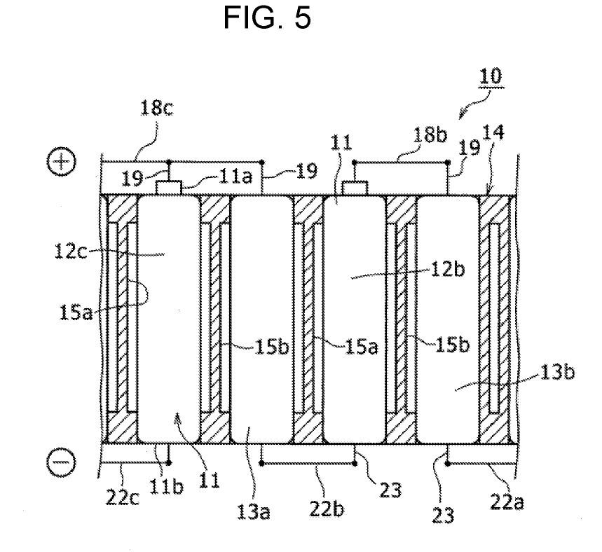

As shown in FIG. 1 and FIG. 5, which is described later, bus bars 13a, 13b are cylindrical and similar in shape to cells 11. As shown in FIG. 2, 15 cells 11 and two bus bars 13 are arranged in a staggered formation and in three rows in widthwise direction W such that a gap between adjacent cells 11 and between any of the cells and bus bar 13 adjacent to each other is kept at a minimum. Seven cells 11 are disposed in the cell row at a first end. (an upper end in FIG. 2) in widthwise direction W; and six cells 11 are disposed in the cell row at a middle in widthwise direction W. Three cells 11 and two bus bars 13 are alternately disposed in the cell row at a second end. (a lower end in FIG. 2) in widthwise direction W.

Cells 11 are cylindrical in outer shape. Of both ends of the cylindrical cell, one end acts as a positive electrode terminal and the other end acts as a negative electrode terminal. As shown in FIG. 5 described later, cell 11 has positive electrode terminal 11a at its upper end and negative electrode terminal 11b at its lower end. In one example, cell 11 is a lithium ion battery having a diameter of 18 mm, a height of 65 mm, a voltage of 3.6 V across the terminals, and a capacity of 2.5 Ah. These figures are provided for purposes of illustration and may be replaced with other dimensions and characteristic values.

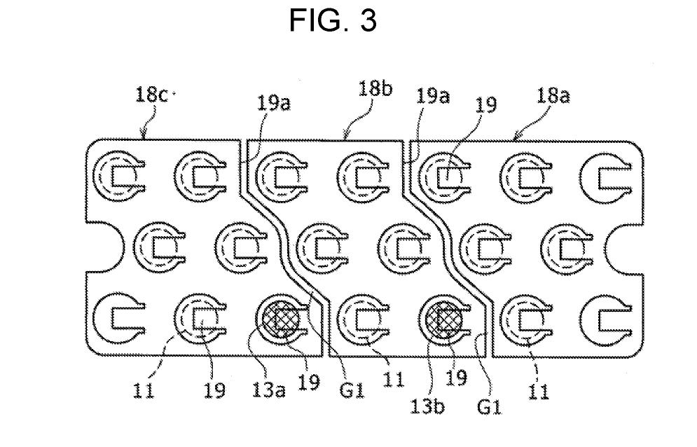

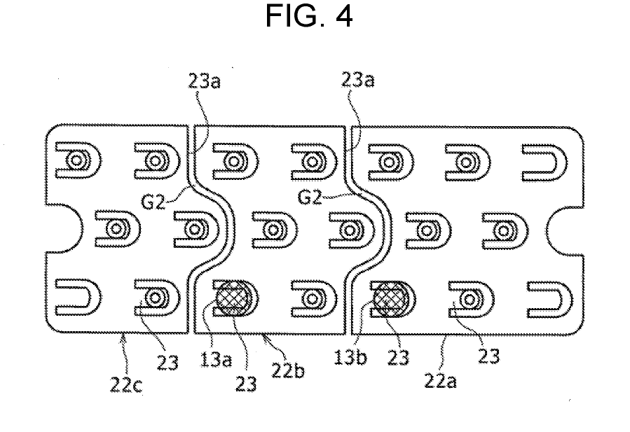

Meanwhile, bus bars 13 are made from a highly conductive metallic material such as copper or an aluminum alloy. Bus bars 13 are cylindrical in outer shape and are substantially identical in shape and size to cells 11. Axial both ends of bus bar 13 may be a simple flat surface in shape. Parts connecting both the ends with an outer peripheral surface of bus bar 13 may be each chamfered so as to have an arc- or straight line-shaped cross section. The chamfered parts allow the bus bars to be readily inserted into second containers 15b (FIG. 5) of cell holder 14 described later. Electrode contact parts 19 (FIG. 3) of positive-electrode current collector plates 18a, 18b, 18c described later are elastically pressed onto one ends of bus bars 13 (upper ends in FIGS. 1 and 5) and these contact parts and ends are connected to each other by welding. Electrode contact parts 23 (FIG. 4) of negative-electrode current collector plates 22a, 22b, 22c described later are elastically pressed onto the other ends of bus bars 13 (lower ends in FIG. 1) and these contact parts and ends are connected to each other by welding. Examples of the welding include ultrasonic welding, resistance welding, and laser welding. Although bus bars 13 exemplified are cylindrical in outer shape, bus bars 13 may have any outer shape other than the cylindrical shape, with proviso that the bus bars can be inserted into second containers 15b of cell holder 14. For example, bus bars 13 may be prismatic or may have disc-shaped upper and lower ends and a column between the connected disc-shaped ends.

With reference back to FIG. 1, cell holder 14 is a holding container containing and holding 15 cells 11 and two bus bars 13 arranged in a predetermined order. A section d of FIG. 1 is a perspective view of cell holder 14. Cell holder 14 is a framework that has a height substantially identical to the height of cells 11. The framework has first containers 15a made up of 18 containers and second containers 15b made up of two containers. The containers each have openings at both ends in height direction H. Two second containers 15b are disposed at a second end of cell holder 14 in widthwise direction W. First and second containers 15a and 15b are identical in shape and size to each other, and are circular in cross section in a plane perpendicular to an axial direction of the containers. As shown in FIG. 5 described later, the openings at both ends of first and second containers 15a and 15b may be smaller in diameter than middle sections of the containers. Cells 11 are disposed and contained in first containers 15a on a one-by-one basis. Bus bars 13a, 13b are disposed and contained in respective two second containers 15b of cell holder 14. This configuration enables bus bars 13 to be disposed in parallel with 15 cells 11 along height direction H. Because of the 15 cells versus 18 first containers 15a, no cells are disposed in three of first containers 15a. The cells may be disposed in all first containers 15a, and bus bars 13 may be disposed in all second containers 15b. In cell holder 14, as described above, bus bars 13 are disposed in second containers 15b, and the second containers are identical in shape to the first containers. Thus, the cell holder can have a conventional structure that is designed to contain only cells. In other words, second containers 15b can contain cells. As a result, in cell holder 14, a space for cell installation and a space for bus bars each serve a double purpose and hence the shape of cell holder 14 does not need to be changed even if the cell holder is to include bus bar 13. This contributes to a reduction both in work time required for changing shapes and in costs for parts of battery module 10. This also contributes to a reduction in verification work required for design changes.

In accordance with the arrangement of cells 11 and bus bars 13 described with the section c of FIG. 1, first and second containers 15a and 15b are arranged in a staggered formation. In other words, two rows of first containers 15a are arranged at the first end (a backside end in FIG. 1) and at the middle in widthwise direction. W, whereas a row including first and second containers 15a and 15b is disposed at the second end (a front end in FIG. 1) in widthwise direction W.

Cell holder 14 thus configured is made primarily from aluminum and formed into a predetermined shape by extrusion molding. Cell holder 14 may be formed from a resin.

When 15 cells 11 are disposed and contained in first containers 15a of cell holder 14, positive electrodes of cells 11 are aligned with a first side and negative electrodes of the cells are aligned with a second side. In FIG. 1, the first side is an upper side in the figure along height direction H, and the second side is a lower side in the figure along height direction H.

Positive-electrode current collector 16 is disposed so as to close the openings of cell holder 14 at the first side and is configured to electrically connect the positive electrodes of arranged cells 11. A section a of FIG. 1 shows positive-electrode current collector 16. Positive-electrode current collector 16 includes positive-electrode insulating board 17 and three positive-electrode current collector plates 18a, 18b, 18c.

Positive-electrode insulating board 17 is a board that is disposed between cell holder 14 and positive-electrode current collector plates 18a, 18b, 18c to insulate electrical conduction therebetween. Positive-electrode insulating board 17 has 20 openings. The positive electrodes of cells 11 protrude through some of the 20 openings. Positive-electrode insulating board 17 is a resin molded part or a resin sheet processed into a predetermined shape, possessing predetermined thermal resistance and electrical insulating properties.

Positive-electrode current collector plates 18a, 18b, 18c are disposed adjacent to the positive electrodes of 15 cells 11. FIG. 3 is an enlarged top view of positive-electrode current collector plates 18a, 18b, 18c illustrated in FIG. 1. Positive-electrode current collector plates 18a, 18b, 18c are each a thin plate having six or seven electrode contact parts 19. Electrode contact parts 19 are disposed so as to be put into elastic contact with the positive electrodes of cells 11 and the one ends of bus bars 13 individually. FIG. 3 shows cells 11 by dashed-line circles and bus bars 13 by circles with a slanting lattice pattern inside. Positive-electrode current collector plates 18a, 18b, 18c are thin metal plates having electric conductivity as well as electrode contact parts each formed into a predetermined shape by etching, press working, or other processing.

Positive-electrode current collector plates 18a, 18b, 18c are disposed face-to-face so as to be a substantially rectangular plate. Positive-electrode current collector plates 18a, 18b, 18c adjacent to each other are separated by each curvilinear separator 19a. Of positive-electrode current collector plates 18a, 18b, 18c, the adjacent positive-electrode current collector plates have an insulating portion therebetween. Preferably, gap G1 is formed between positive-electrode current collector plates 18a, 18b, 18c adjacent to each other.

Positive-terminal-side parallel group 12a of three parallel groups 12a, 12b, 12c (FIG. 2) is connected to positive-electrode current collector plate 18a of plates 18a, 18b, 18c at the first end (a right end in FIG. 1) in lengthwise direction L. Positive-electrode current collector plate 18a at the first end in lengthwise direction L can act as a positive electrode terminal of battery module 10 and be connected to a negative electrode component of another battery module via a positive electrode component (not shown). Of a plurality of battery modules 10 connected in series, a battery module disposed at the positive terminal side has positive-electrode current collector plate 18a at the first end in lengthwise direction L, and a positive electrode terminal of an electrical load can be connected to the positive-electrode current collector plate. Of positive-electrode current collector plates 18a, 18b, 18c, positive-electrode current collector plate 18c at the second end (a left end in FIG. 1) in lengthwise direction L is connected to parallel group 12c at the negative terminal side. Positive-electrode current collector plate 18b at the middle in lengthwise direction L is connected to parallel group 12b at the middle.

Negative-electrode current collector 20 is disposed at the openings of cell holder 14 at the second side and is configured to electrically connect the negative electrodes of arranged cells 11. A section e of FIG. 1 shows negative-electrode current collector 20. Negative-electrode current collector 20 includes negative-electrode insulating board 21 and three negative-electrode current collector plates 22a, 22b, 22c.

Negative-electrode insulating board 21 is a board that is disposed between cell holder 14 and negative-electrode current collector plates 22a, 22b, 22c to insulate electrical conduction therebetween. Negative-electrode insulating board 21 has 20 openings. The negative electrodes of cells 11 are exposed through some of the 20 openings. Negative-electrode insulating board 21 is a resin molded part or a resin sheet processed into a predetermined shape, possessing predetermined thermal resistance and electrical insulating properties.

Negative-electrode current collector plates 22a, 22b, 22c are disposed adjacent to the negative electrodes of 15 cells 11. FIG. 4 is an enlarged top view of negative-electrode current collector plates 22a, 22b, 22c illustrated in FIG. 1. Negative-electrode current collector plates 22a, 22b, 22c are each an electrode member having six or eight electrode contact parts 23. Electrode contact parts 23 are disposed so as to be put into contact with the negative electrodes of cells 11 and the other ends of bus bars 13 individually. FIG. 4 shows the disposition of cells 11 by double circles and bus bars 13 by circles with a slanting lattice pattern inside. Negative-electrode current collector plates 22a, 22b, 22c are thin metal plates having electric conductivity as well as electrode contact parts each formed into a predetermined shape by etching, press working, or other processing.

Negative-electrode current collector plates 22a, 22b, 22c are disposed face-to-face so as to be a substantially rectangular plate. Negative-electrode current collector plates 22a, 22b, 22c adjacent to each other are separated by each curvilinear separator 23a. Of negative-electrode current collector plates 22a, 22b, 22c, the adjacent negative-electrode current collector plates have an insulating portion therebetween. Preferably, gap G2 is formed between negative-electrode current collector plates 22a, 22b, 22c adjacent to each other.

Negative-terminal-side parallel group 12c of three parallel groups 12a, 12b, 12c (FIG. 2) is connected to negative-electrode current collector plate 22c of plates 22a, 22b, 22c at the second end (the left end in FIG. 1) in lengthwise direction L. Negative-electrode current collector plate 22c at the second end in lengthwise direction L can act as a negative electrode terminal of battery module 10 and be connected to a positive electrode component of another battery module via a negative electrode component (not shown). Of the plurality of battery modules 10 connected in series, a battery module disposed at the negative terminal side has negative-electrode current collector plate 22c at the second end in lengthwise direction L, and a negative electrode terminal of an electrical load can be connected to the negative-electrode current collector plate. Of negative-electrode current collector plates 22a, 22b, 22c, negative-electrode current collector plate 22a at the first end (the right end in FIG. 1) in lengthwise direction L is connected to parallel group 12a at the positive terminal side. Negative-electrode current collector plate 22b at the middle in lengthwise direction L is connected to parallel group 12b at the middle.

FIG. 5 is an enlarged cross-sectional view taken from line A-A of FIG. 1, with cells 11 contained in cell holder 14 in FIG. 1. As described above, three parallel groups 12a, 12b, 12c are connected in series via bus bars 13a, 13b. In the following description, two bus bars 13a, 13b are referred to as first bus bar 13a and second bus bar 13b for convenience. In this state, one end of first bus bar 13a is connected to one electrode contact part 19 of positive-electrode current collector plate 18c at the negative terminal side of battery module 10. In FIG. 5, positive-electrode current collector plates 18b, 18c and negative-electrode current collector plates 22a, 22b, 22c are schematically shown by bent lines. The other end of first bus bar 13a is connected to one electrode contact part 23 of negative-electrode current collector plate 22b at the middle. Consequently, parallel group 12c at the negative terminal side is connected in series with parallel group 12b at the middle via first bus bar 13a.

One end of second bus bar 13b is connected to one electrode contact part 19 of positive-electrode current collector plate 18b at the middle. The other end of second bus bar 13b is connected to one electrode contact part 23 of negative-electrode current collector plate 22a at the positive terminal side of battery module 10. Consequently, parallel group 12b at the middle is connected in series with parallel group 12a at the positive terminal side (FIG. 2) via second bus bar 13b.

A surface center of the one end of bus bar 13 may have a protrusion similar in shape to the positive electrode terminal of cell 11. This enables the bus bars to be contact with electrode contact parts 19 of positive-electrode current collector plates 18a, 18b, 18c more similarly to cells 11.

With reference back to FIG. 1, posts 24, 25 are configured to fasten positive-electrode current collector 16 disposed at the first side of cell holder 14 and negative-electrode current collector 20 disposed at the second side together using screws or other fasteners (not shown). Posts 24, 25 are made from an insulating material and are integrated with cell holder 14, positive-electrode current collector 16, and negative-electrode current collector 20 to form a whole. A section b of FIG. 1 shows posts 24, 25. In this example, post 24 at the right side and post 25 at the left side in the figure are disposed at both ends of cell holder 14 in lengthwise direction L.

As shown in the section b of FIG. 1, posts 24, 25 are disposed so as to be put on depressions 14a formed in both sides of cell holder 14 in lengthwise direction L. This prevents components from getting misaligned in widthwise direction W. Middle parts of posts 24, 25 in widthwise direction W may have thread portions for fasteners at their ends in the height direction.

In battery module 10 thus configured, cell holder 14 contains cells 11 such that the positive electrodes of cells 11 are aligned with the first side and the negative electrodes of the cells are aligned with the second side and that positive-electrode current collector 16 is disposed on the positive electrodes and negative-electrode current collector 20 is disposed on the negative electrodes. These components are integrated through posts 24, 25 using screws or other fasteners.

Battery module 10 described above allows alteration of a connection pattern for cells 11 without any change in orientation of cells 11 and cell holder 14.

In battery module 10 described above, five pieces of cells 11 are disposed in each one of parallel groups 12a, 12b, 12c and three parallel groups 12a, 12b, 12c are connected in series, for example. In other words, the cells in this example have a connection pattern in which a number of the parallel-connected cells is five and a number of the series-connected groups is three. The number of the parallel-connected cells may be increased to have an increased capacity. The number of parallel-connected cells is primarily determined by a size of each current collector plate. Meanwhile, the number of the series-connected groups may be increased to have a higher voltage.

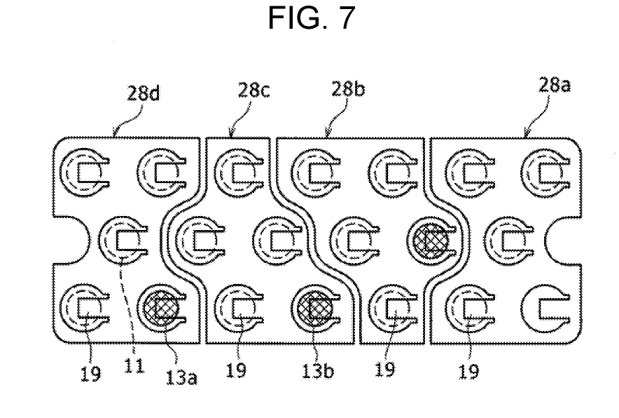

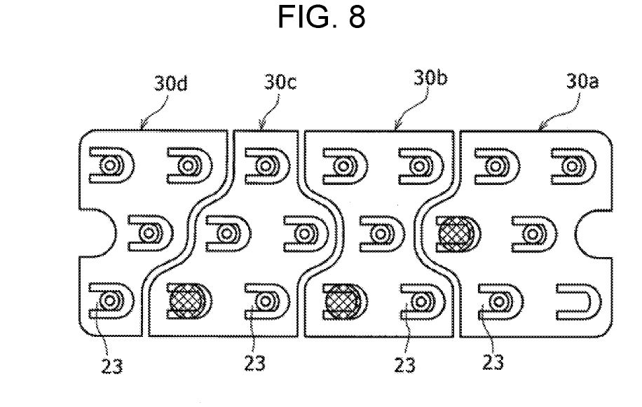

For example, as in a third example shown in FIGS. 7 and 8 described later, the cells may have a connection pattern in which the number of the parallel-connected cells is four and the number of the series-connected groups is four. This instance provides a higher voltage due to an increase in the number of the series-connected groups despite a smaller capacity owing to a decrease in the number of the parallel-connected cells compared to the configuration in the preceding example. Thus, this configuration does not require changing the cells' orientation and cell holder 14 even if the connection pattern for the cells is altered. Moreover, this configuration does not require changing an overall size and shape of battery module 10 in response to an alteration in the connection pattern for the cells. This allows the battery module to implement various cell connection patterns in a limited disposition space.

In the description given above, the plurality of battery modules is connected in series, for example. However, a single battery module may be independently used as a power source for an electric device.

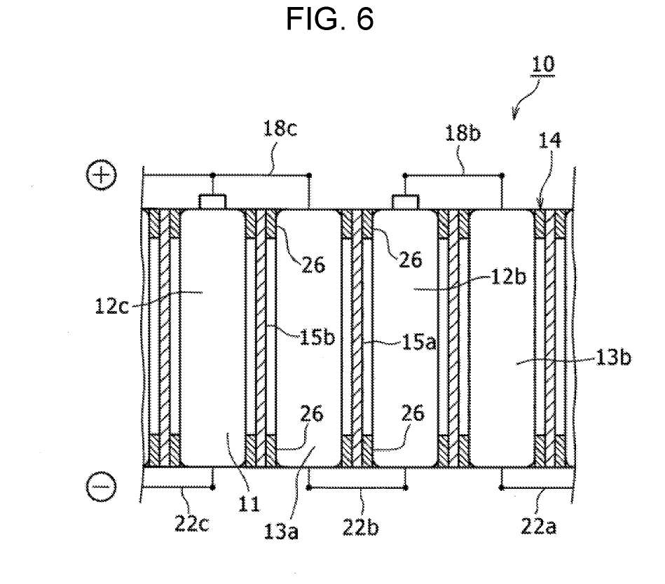

FIG. 6 is a drawing comparable to FIG. 5, illustrating battery module 10 according to a second example of the exemplary embodiment. Cell holder 14 in this example has first containers 15a and second containers 15b that are cylindrical holes. First and second containers 15a and 15b each have ring-shaped insulating materials 26 at both ends. Cells 11 and bus bars 13 are disposed contiguous to insulating materials 26 in respective containers 15a, 15b. Preferably, insulating material 26 has a lower thermal conductivity than the material from which cell holder 14 is made. In the case of abnormal heat generation by some of the cells, insulating materials 26 serve to counteract influence of the heat on the other normal cells. Preferably, insulating material 26 is a substance containing a high heat resistance resin. Insulating materials 26 are disposed only at both ends of the cell, so that an air layer is formed between a middle part of the cell and first container 15a. This configuration provides improved heat-insulating function because the air layer has a lower thermal conductivity than insulating materials 26.

Like first containers 15a, second containers 15b each have insulating materials 26 at both ends. The insulating materials are disposed between bus bar 13 and second container 15b. This configuration, even if bus bar 13 reaches a high temperature, hinders influence of the heat from extending to cells. Apart from the description above, this example is similar in configuration and action to the example shown in FIGS. 1 to 5.

FIG. 7 is a drawing comparable to FIG. 3, illustrating positive-electrode current collector plates 28a, 28b, 28c, 28d of a battery module according to the third example of the exemplary embodiment. FIG. 8 is a drawing comparable to FIG. 4, illustrating negative-electrode current collector plates 30a, 30b, 30c, 30d of the battery module according to the third example.

In this example, the battery module includes the four divided positive-electrode current collector plates and the four divided negative-electrode current collector plates. In this example, four pieces of cells 11 are disposed in each one of four parallel groups and the four parallel groups are connected in series in the battery module. In other words, the cells in this example have a connection pattern in which the number of the parallel-connected cells is four and the number of the series-connected groups is four. Both ends of each bus bar 13a, 13b, 13c contained and held in the cell holder are connected to one of positive-electrode current collector plates 28a, 28b, 28c, 28d and one of negative-electrode current collector plates 30a, 30b, 30c, 30d such that the adjacent parallel groups are electrically connected in series. In this way, the connection pattern for the cells can be altered by only changing the shapes and the numbers of disposed positive- and negative-electrode current collector plates from the configuration shown in FIGS. 1 to 5 without any change in the cells' orientation and the cell holder. This configuration can provide various electrical connection patterns only by changing current collector plate shapes. Thus, the present disclosure can provide a battery module including identically-shaped and standardized cells and being capable of meeting various specification requirements by selecting any desired numbers of parallel-connected cells and series-connected groups. Apart from the description above, this example is similar in configuration and action to the example shown in FIGS. 1 to 5.

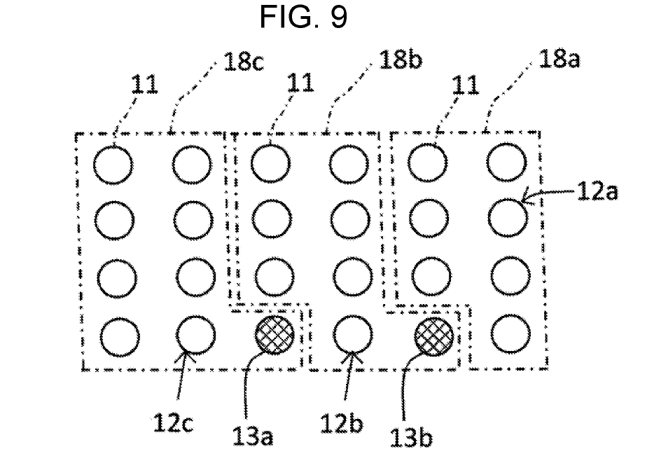

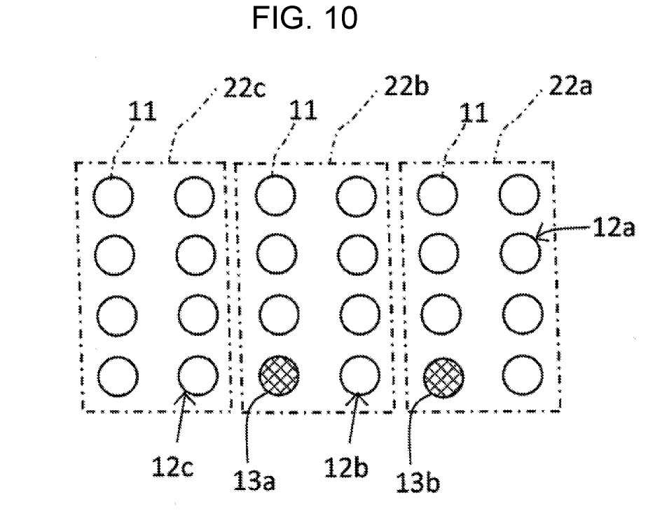

FIG. 9 is a schematic top view illustrating a positional relationship among a plurality of cells 11, bus bars 13a, 13b, and positive-electrode current collector plates 18a, 18b, 18c of a battery module according to a fourth example of the exemplary embodiment. FIG. 10 is a schematic top view illustrating a positional relationship among the plurality of cells 11, bus bars 13a, 13b, and negative-electrode current collector plates 22a, 22b, 22c of the battery module according to the fourth example.

In the battery module of this example, negative-terminal-side parallel group 12c made up of eight cells 11 and middle- and positive-terminal-side parallel groups 12b, 12a each made up of seven cells 11 are connected in series via bus bars 13a, 13b. Cells 11 and bus bars 13 are not arranged in a staggered formation but are aligned and adjacent to each other in the lengthwise and widthwise directions. The cells in this example have a connection pattern in which the number of the parallel-connected cells is eight or seven and the number of the series-connected groups is three. In this way, thee parallel group 12a, 12b, 12c are connected in series via positive- and negative-electrode current collector plates and bus bars 13. Apart from the description above, this example is similar in configuration and action to the example shown in FIGS. 1 to 5.

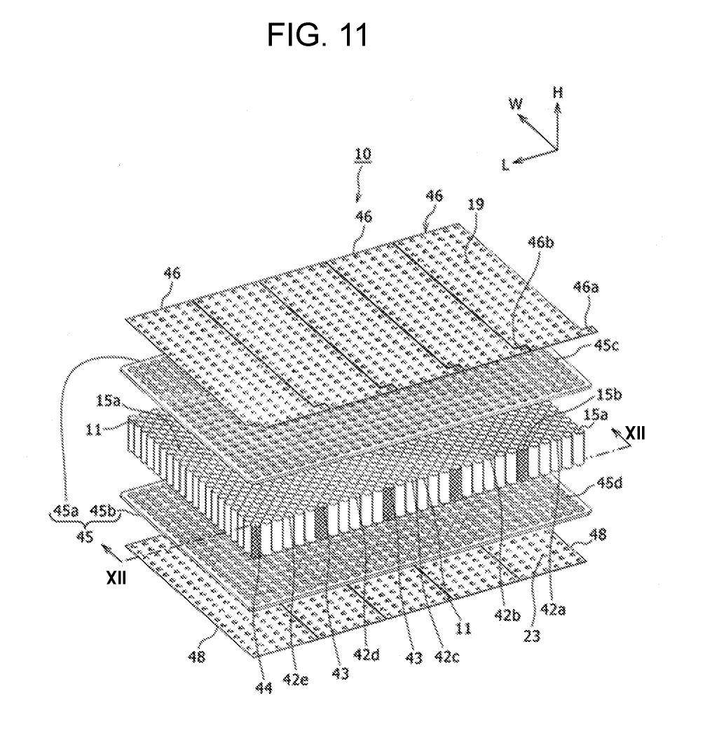

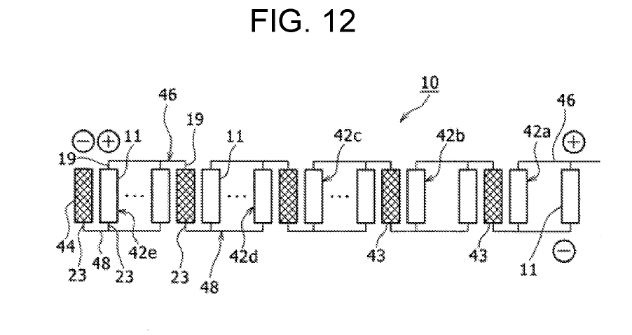

FIG. 11 is an exploded perspective view illustrating an overall configuration of battery module 10 according to a fifth example of the exemplary embodiment. Battery module 10 shown in FIG. 11 is a representation of a battery module including a plurality of components stacked in what is called a rack. FIG. 12 is a view corresponding to a cross-sectional view illustrating a connected state of cells 11 in FIG. 11 omitting upper holder plate 45a and lower holder plate 45b of cell holder 45, viewed along line B-B in FIG. 11. In the battery module of this example, five parallel groups 42a, 42b, 42c, 42d, 42e each made up of 119 cells 11 are connected in series via four intermediate bus bars 43. Negative-terminal-side bus bar 44 is connected to parallel group 42e at the negative terminal side (a left end in FIG. 11). Negative-terminal-side bus bar 44 functions as a negative electrode terminal of battery module 10.

Cell holder 45 is formed of upper and lower holder plates 45a, 45b that hold upper and lower portions of cells 11 (height direction H) to restrict lateral positions of cells 11 (in lengthwise direction L and widthwise direction W). The plurality of cells 11 positioned by cell holder 45 is aligned and adjacent to each other in lengthwise and widthwise directions L and W, while intermediate bus bars 43 and negative-terminal-side bus bar 44 are included in a row at the second end in widthwise direction W (a front end in FIG. 11). FIG. 12 shows intermediate bus bars 43 and negative-terminal-side bus bar 44 by a slanting lattice pattern. In the battery module omitting the row at the second end in widthwise direction W, sets of the plurality of cells 11 are aligned in lengthwise and widthwise directions L and W. At the second end of cell holder 45 in widthwise direction W, five cells 11 and one intermediate bus bar 43 or negative-terminal-side bus bar 44 are alternately arranged along lengthwise direction. L. In FIG. 11, cells 11 are represented by cylinders without an internal pattern, whereas intermediate bus bars 43 and negative-terminal-side bus bar 44 are represented by cylinders with a slanting lattice pattern.

Cells 11 are contained in cell holder 45, and five positive-electrode current collector plates 46 are disposed at the first side of cells 11 in height direction H (the upper side in FIG. 11), with upper holder plate 45a interposed between the cells and the current collector plates. Upper holder plate 45a has a plurality of holes 45c that serves as a container to contain upper portions of cells 11. Upper portions of intermediate bus bars 43 and negative-terminal-side bus bar 44 are positioned and disposed in some of the plurality of holes 45c. The plurality of positive-electrode current collector plates 46 is rectangular and identical in shape to one another, and is aligned along lengthwise direction L. Positive-electrode current collector plates 46 each have protrusion 46a being disposed at the second end in widthwise direction W and projecting to the first side in lengthwise direction L (the right side in FIG. 11) and recess 46b being depressed at the second side in the lengthwise direction (the left side in FIG. 11). Protrusion 46a of one of two positive-electrode current collector plates 46 adjacent to each other in lengthwise direction L fits into recess 46b of the other positive-electrode current collector plate.

Cells 11 are contained in cell holder 45, and five negative-electrode current collector plates 48 are disposed at the second side of cells 11 in height direction H (the lower side in FIG. 11), with lower holder plate 45b interposed between the cells and the current collector plates. Lower holder plate 45b has a plurality of holes 45d that serves as a container to contain lower portions of cells 11. Lower portions of intermediate bus bars 43 and negative-terminal-side bus bar 44 are positioned and disposed in some of the plurality of holes 45d. The plurality of negative-electrode current collector plates 48 is rectangular and identical in shape to one another, and is aligned along lengthwise direction L.

First sides of intermediate bus bars 43 in height direction H are connected to electrode contact parts 19 formed on protrusions 46a at the first ends (the right ends in FIG. 11) of positive-electrode current collector plates 46 in lengthwise direction L, whereas second sides of the intermediate bus bars in height direction H are connected to electrode contact parts 23 formed at the second ends (the left ends in FIG. 11) of negative-electrode current collector plates 48 in lengthwise direction L. Negative-electrode current collector plate 48 at the second end in lengthwise direction L has electrode contact part 23 at the second end in lengthwise direction L and at the second end in widthwise direction W (at the front end in FIG. 11), and negative-terminal-side bus bar 44 is connected to electrode contact part 23 in question.

The positive electrode terminals of cells 11 are connected to electrode contact parts 19 of positive-electrode current collector plates 46, and the negative electrode terminals of the cells are connected to electrode contact parts 23 of negative-electrode current collector plates 48. Thus, the plurality of cells 11 are connected in parallel by respective positive- and negative-electrode current collector plates 46 and 48 and are hence divided into five parallel groups 42a, 42b, 42c, 42d, 42e. Five parallel groups 42a, 42b, 42c, 42d, 42e are connected in series via four intermediate bus bars 43. In this state, protrusion 46a of positive-electrode current collector plate 46 disposed at the first end (the right end in FIGS. 11 and 12) in lengthwise direction L, i.e. at the positive terminal side, acts as a positive electrode terminal of battery module 10. The battery module in this example does not have posts 24, 25 (FIG. 1) included in the configuration shown in FIGS. 1 to 5. Instead, positive-electrode current collector plates 46, upper and lower holder plates 45a and 45b, and negative-electrode current collector plates 48 are combined together by binding means (not shown). The biding mean may be a cell case (not shown) that contains positive-electrode current collector plates 46, upper and lower holder plates 45a and 45b, and negative-electrode current collector plates 48 inside. Apart from the description above, this example is similar in configuration and action to any of the examples shown in FIGS. 1 to 5 or FIGS. 9 and 10.

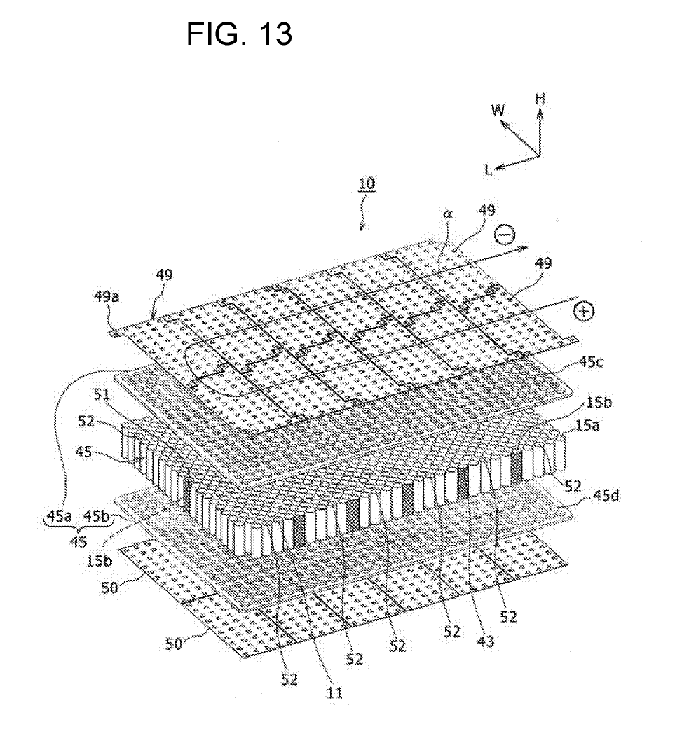

FIG. 13 is an exploded perspective view illustrating an overall configuration of battery module 10 according to a sixth example of the exemplary embodiment. The battery module in this example includes 12 positive-electrode current collector plates 49 and 12 negative-electrode current collector plates 50 in such a way that the battery module in FIGS. 11 and 12 has positive- and negative-electrode current collector plates that are divided into respective two pieces in each column in widthwise direction W and that are divided into respective six pieces in each row in lengthwise direction L.

While a plurality of cells 11 is positioned by cell holder 45, a cell container disposed at the second end (the left end in FIG. 13) in lengthwise direction L and at a middle part in widthwise direction W has no single cell. Instead, the cell container contains second intermediate bus bar 51 that is positioned and arranged by cell holder 45. Second intermediate bus bar 51 connects negative-electrode current collector plate 50 disposed at the second side in widthwise direction W (a front side in FIG. 13) with positive-electrode current collector plate 49 disposed at the first side in widthwise direction W (a backside in FIG. 13).

Positive-electrode current collector plates 49 adjacent to each other in widthwise direction W are disposed so as to be symmetric with respect to a center point, i.e. rotation by an angle of 180° does not change the object in shape as viewed from the first side in height direction H. Positive-electrode current collector plates 49 are all identical in shape and are disposed in opposing orientations. The plurality of cells 11 is divided into 12 parallel groups 52, i.e. six groups in each row in lengthwise direction L and two groups in each column in widthwise direction W. Parallel groups 52 aligned along lengthwise direction L are connected in series via intermediate bus bars 43. In cell holder 45, like the intermediate bus bars at the second end in widthwise direction W (at the front end in FIG. 13), five intermediate bus bars are positioned and arranged at the first end in widthwise direction W (the backside end in FIG. 13) although they are hidden in FIG. 13.

The positive electrode terminals of cells 11 are connected to electrode contact parts of positive-electrode current collector plates 49, and the negative electrode terminals of the cells are connected to electrode contact parts of negative-electrode current collector plates 50. In other words, parallel groups 52 adjacent to each other in widthwise direction W except the groups at the second end (the left end in FIG. 13) of cell holder 45 in lengthwise direction L do not include second intermediate bus bar 51 and thus are not electrically connected to each other. At the same time, parallel groups 52 being disposed at the second end of cell holder 45 in lengthwise direction L and being adjacent to each other in widthwise direction W include second intermediate bus bar 51 and thus are connected in series. This configuration allows the plurality of parallel groups 52 to be connected in series from the positive terminal side to the negative terminal side as indicated with arrow a in FIG. 13. In other words, a starting end and an ending end of series-connected parallel groups 52 are disposed at an identical side of cell holder 45.

In the battery module of this example, 12 parallel groups 52 each made up of 50 cells 11 are connected in series via the plurality of intermediate bus bars 43 and second intermediate bus bar 51. A negative-terminal-side bus bar (not shown) is connected to the parallel group (not shown) being disposed at the negative terminal side and being disposed at the first end (the backside end in FIG. 13) in widthwise direction W and at the first end (the right end in FIG. 13) in lengthwise direction L. The negative-terminal-side bus bar functions as a negative electrode terminal of battery module 10. Positive-electrode current collector plate 49 disposed at the first end in widthwise direction W and at the second end (the left end in FIG. 13) in lengthwise direction L has protrusion 49a projecting in lengthwise direction L. Protrusion 49a in question may be used as an intermediate terminal. Apart from the description above, this example is similar in configuration and action to the example shown in FIGS. 11 and 12.

### REFERENCE MARKS IN THE DRAWINGS

10: battery module
11: cell
11a: positive electrode terminal
11b: negative electrode terminal
12a, 12b, 12c: parallel group
13a, 13b: bus bar
14: cell holder
14a: depression
15a: first container
15b: second container
16: positive-electrode current collector
17: positive-electrode insulating board
18a, 18b, 18c: positive-electrode current collector plate
19: electrode contact part
19a: separator
20: negative-electrode current collector
21: negative-electrode insulating board
22a, 22b, 22c: negative-electrode current collector plate
23: electrode contact part
23a: separator
24, 25: post
26: insulating material
28a, 28b, 28c, 28d: positive-electrode current collector plate
30a, 30b, 30c, 30d: negative-electrode current collector plate
42a, 42b, 42c, 42d, 42e: parallel group
43: intermediate bus bar
44: negative-terminal-side bus bar
45: cell holder
45a: upper holder plate
45b: lower holder plate
45c, 45d: hole
46: positive-electrode current collector plate
46a: protrusion
46b: recess
48: negative-electrode current collector plate
49: positive-electrode current collector plate
49a: protrusion
50: negative-electrode current collector plate
51: second intermediate bus bar
52: parallel group
53: parallel connection group.

1. A battery module comprising:
a plurality of cells being each cylindrical and being held in a cell holder in such a manner that the cells are arranged with positive electrodes disposed at a first side and negative electrodes disposed at a second side;
a plurality of positive-electrode current collector plates disposed adjacent to the positive electrodes of the plurality of cells;
a plurality of negative-electrode current collector plates disposed adjacent to the negative electrodes of the plurality of cells; and
a bus bar being disposed in a container in the cell holder and being parallel to the plurality of cells, the container being capable of containing any one of the cells,
wherein
both ends of the bus bar are connected to one of the plurality of positive-electrode current collector plates and one of the plurality of negative-electrode current collector plates, respectively.

2. The battery module according to claim 1, wherein
the cell holder includes first containers acting as a plurality of the containers to contain and hold the plurality of respective cells, and
the bus bar is contained and held in a second container acting as the container in which the second container is formed in the cell holder and is identical in shape and size to the first containers.

3. The battery module according to claim 1, wherein
the plurality of cells contained in the cell holder are connected in parallel by the plurality of respective positive-electrode current collector plates and the plurality of respective negative-electrode current collector plates and are divided into a plurality of parallel groups,
the plurality of positive-electrode current collector plates is identical in shape to each other and the plurality of negative-electrode current collector plates is identical in shape to each other, and
the plurality of parallel groups is made up of identical numbers of the respective plurality of cells and the parallel groups adjacent to each other are connected in series via the bus bar.

4. The battery module according to claim 3, wherein
the plurality of positive-electrode current collector plates and the plurality of negative-electrode current collector plates have respective portions facing the bus bar and being different in shape to each other, and
one of the positive-electrode current collector plates corresponding to predetermined one of the parallel groups is connected to a first end of the bus bar, and one of the negative-electrode current collector plates corresponding to any of the parallel groups adjacent to the predetermined one of the parallel groups is connected to a second end of the bus bar.

5. The battery module according to claim 3, wherein
the plurality of parallel groups connected in series has an arrangement of a plurality of rows and a plurality of columns, and
a starting end and an ending end of the plurality of series-connected parallel groups are disposed at an identical side of the cell holder.
